(19) United States
(12) Patent Application Publication
(10) Pub. No.: US 2005/0093295 A1
(43) Pub. Date: May 5, 2005

(54) Hydraulic swivel fitting for a dispensing apparatus

(75) Inventors: David J. Byerly, Lawrenceville, GA (US); Edward C. Taylor, Cumming, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation, Westlake, OH (US)

(21) Appl. No.: 10/698,274

(22) Filed: Oct. 31, 2003

(51) Int. Cl. F16L 27/04

(52) U.S. Cl. 285/261

(57) ABSTRACT

A hydraulic swivel fitting for establishing a fluid connection with a liquid dispenser. The swivel fitting includes a fluid cavity housing a socket assembly, a ball member that rotates and tilts within the socket assembly, and a stem that is received within a bore in the ball member with a liquid-tight seal. The stem is movable within the bore so that axial forces applied to a supply conduit coupled with the stem are not transferred to the ball member. Instead, such axial forces are diverted from the stem to the housing of the swivel member and, subsequently, transferred from the housing to the liquid dispenser.

### FIELD OF THE INVENTION

The invention relates generally to dispensing apparatus, and, more particularly, to dispensing apparatus having ball-and-socket style hydraulic swivel fittings for conveying liquid.

### BACKGROUND OF THE INVENTION

Handheld dispensers have many commercial and industrial applications for dispensing liquids such as hot melt adhesives, sealants and other thermoplastic materials. Handheld dispensers are routinely coupled to a liquid source by a supply conduit that supplies pressurized liquid to the dispenser. A swivel fitting is frequently used for rotatably coupling the supply conduit to the dispenser. The swivel coupling prevents twisting of the supply conduit and improves the operator's ability to orient the handheld dispenser relative to the supply conduit.

A common type of swivel hydraulic fitting for a handheld dispenser includes a spherical-shaped ball captured in a rotatable engagement with a socket, such as the hydraulic fitting disclosed in U.S. Pat. No. 5,507,534, assigned to the assignee of the present invention. The supply conduit is connected to a coupling located at the free end of a stem extending away from the ball. Defined along the length of the stem is a liquid passageway that penetrates to approximately the centerpoint of the ball. Radial passageways extend from the liquid passageway to a liquid chamber defined inside the hydraulic fitting that transfers the liquid from the liquid passageway in the stem to the handheld dispenser. As the ball rotates and tilts inside the socket, flow in the liquid pathway defined inside the hydraulic fitting from the conduit to the handheld dispenser is uninterrupted and continuous. The hydraulic fitting advantageously relieves axially-directed internal forces applied to the ball by the pressurized liquid in the liquid pathway, which reduces binding as the ball tilts and rotates relative to the socket. The hydraulic fitting also has an extended operational life as premature wear of the ball and socket is reduced.

Nevertheless, there is still a need for improvements in relation to solving the same or similar axial loading problems arising from axially directed external forces or pull loads applied to the conduit that are transferred to the swivel member. External axial pull loads are applied to the hydraulic fitting when, for example, the supply conduit snags or catches on objects in the work environment of the operator. External axial pull loads are also applied to the supply conduit by the weight of the supply conduit itself.

It would be desirable, therefore, to provide a swivel hydraulic fitting resistant to externally-applied axial pull loads while retaining a resistance to internally-applied axial pull loads arising from the pressurized fluid.

### SUMMARY

In one aspect, the invention is directed to a hydraulic swivel fitting for transferring a liquid to a liquid dispenser and a liquid dispenser having the hydraulic swivel fitting. The swivel fitting includes a housing having a fluid cavity coupled in fluid communication with an internal fluid pathway of the dispenser and a socket assembly positioned in the fluid cavity. A ball member of the swivel fitting is engaged for movement with the socket assembly. A stem of the swivel fitting is received with in a bore extending through the ball member and has a liquid-tight engagement with the ball member. The stem features a liquid passageway coupled in fluid communication with the fluid cavity. The stem is axially movable along the bore for transferring an axial force directed along the stem to the housing.

In another aspect, a method of transferring a liquid includes mechanically coupling a housing of a hydraulic swivel fitting with a dispenser, hydraulically coupling a liquid passageway in a stem of the swivel fitting with a supply conduit to receive a flow of the liquid, and conveying the liquid from the liquid passageway through the swivel fitting to the internal fluid pathway of the liquid dispenser. The method further includes allowing a ball member of the swivel fitting to swivel and tilt relative to a socket assembly enclosed in the swivel fitting and transferring an axial force applied by the supply conduit to the stem from the stem to the mechanically-coupled housing and subsequently from the housing to the dispenser without significant force transfer to the ball member.

In accordance with the preferred embodiment of the invention, the hose pull load on a ball-and-socket swivel hydraulic fitting is significantly reduced, or eliminated, by segmenting the swivel member into two distinct relatively-movable components, namely a ball member and a stem received in a bore extending through the ball member. Consequently, an applied axial pull load moves the stem relative to the ball member so that a portion of the stem contacts the main body or housing of the hydraulic fitting. The contacting relationship is effective to transfer the axial force from the stem to the housing, and subsequently to the handheld dispenser, rather to the ball member and the dynamic seals or o-rings that engage the convex outer surface of the ball member to prevent leakage.

These and other objects and advantages of the present invention shall become more apparent from the accompanying drawings and description thereof.

### BRIEF DESCRIPTION OF THE FIGURES

The accompanying drawings, which are incorporated in and constitute a part of this specification, illustrate embodiments of the invention and, together with a general description of the invention given above, and the detailed description given below, serve to explain the principles of the invention.

FIG. 1 is a side perspective view of a dispensing handgun incorporating a swivel fitting constructed in accordance with the principles of the invention;

FIG. 2 is a cross-sectional view of a portion of FIG. 1 taken generally along the mid-plane of FIG. 1 in which an outward axial force is applied to the stem; and

FIG. 3 is a cross-sectional view similar to FIG. 2 in which an inward axial force is applied to the stem.

### DETAILED DESCRIPTION OF THE PREFERRED EMBODIMENT

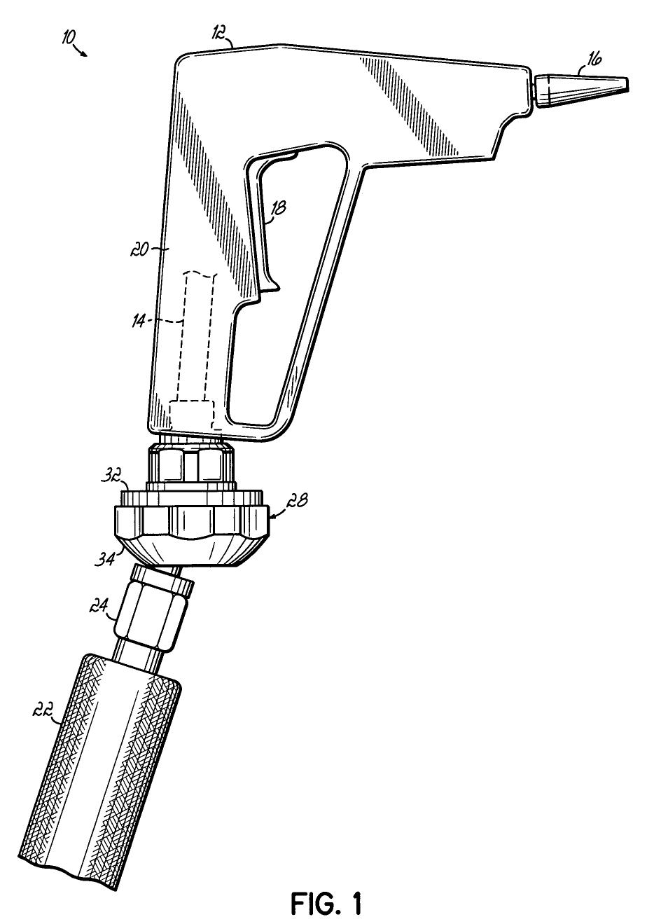

With reference to FIG. 1, a handheld dispenser 10 generally includes a flow-controlled dispenser body 12 having an internal fluid pathway 14 leading to a nozzle tip 16 having an orifice therein from which liquid is dispensed. Positioned in the internal fluid pathway 14 is a valve element (not shown) movable between open and closed conditions to permit liquid flow through the internal fluid pathway 14 to the nozzle tip 16, which affords an operator the ability to regulate and interrupt the stream of liquid dispensed from the handheld dispenser 10. The valve element is operated by manually actuating or otherwise depressing an external trigger 18 in reaction to which the valve element moves to the open condition for permitting liquid to flow to, and be dispensed, as a spray or stream from the nozzle tip 16. The flow volume to the nozzle tip 16 is regulated by the degree by which the trigger 18 is depressed. Releasing the trigger 18 ceases the flow of liquid through the internal fluid pathway to the nozzle tip 16 and provides the closed condition. The dispenser body 12 includes a handgrip 20 that is grasped for moving the handheld dispenser 10 to orient the nozzle tip 16 relative to an object receiving the dispensed liquid. The handheld dispenser 10 may be operated in a vertical orientation, a horizontal orientation, or any intermediate orientation between vertical and horizontal.

References herein to terms such as “vertical”, “horizontal”, etc. are made by way of example, and not by way of limitation, to establish a frame of reference. It is understood various other frames of reference may be employed without departing from the spirit and scope of the invention.

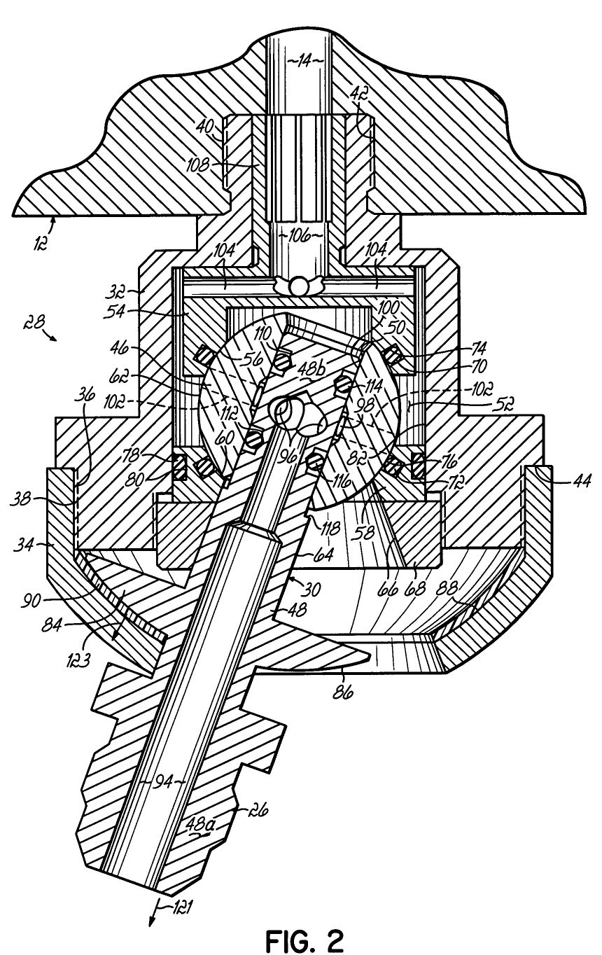

A supply hose or conduit 22 is removably attached to the handheld dispenser 10 by a female hydraulic coupling element 24 for connecting with a complementary male hydraulic coupling element 26 (FIG. 2) of a hydraulic fitting 28 constructed in accordance with principles of the invention. The hydraulic coupling elements 24, 26 may be threaded coupling members or, alternatively, may constitute quick release fitting elements. Liquid is supplied from a pressurized liquid source to the fluid pathway 14 of the handheld dispenser 10 through an internal lumen extending along the length of the supply conduit 22, which may be insulated and/or heated for reducing radially-outward heat transfer that would otherwise cool heated liquids flowing through the internal lumen. The liquid supplied to the handheld dispenser 10 by supply conduit 22 may be, for example, a heated thermoplastic material or a hot melt adhesive.

The principles of the invention are also applicable to other types of handheld dispensers including, but not limited to, paint spray applicators, fuel dispensers and pneumatic tools. Other types of non-handheld dispensers supported by a structural framework may also benefit from application of the principles of the invention.

With reference to FIGS. 1 and 2, the hydraulic fitting 28 generally includes a swivel member 30, a main body or housing 32, and a dome-shaped cap 34 having an internally-threaded portion 36 that attaches to an externally-threaded portion 38 of the housing 22. The threaded attachment of the cap 34 to the housing 32 secures the swivel member 30 within the housing 32. Another threaded region 40 on the housing 32 mates with a threaded inlet 42 to the internal fluid pathway 14 of the handheld dispenser 10. A circumferential shoulder 44 defined in housing 32 adjacent to the externally threaded portion 38 defines a stop that limits tightening of the cap 34. The swivel member 30 includes a spherical-shaped ball member or ball 46 and a stem 48 having a leading end extending into a bore 50 extending through the ball 46. Stem 48 is axially-movable over a limited range of axial movement relative to the ball 46, as detailed below.

Ball 46 is mounted within the housing 32 for rotation and limited angular displacement relative to the housing 32. To that end, a socket assembly situated inside a fluid cavity 52 defined inside the housing 32 includes an upper cup-shaped socket 54 carrying a circumferential, concave bearing surface 56 and a floating sealing member 58 carrying another circumferential, concave bearing surface 60. The generally confronting bearing surfaces 56, 60 each have a surface area that contacts a convex outer surface 62 of the ball 46 for guiding the swivel member 30 as it rotates and tilts relative to the housing 32. The curvature of the convex outer surface 62 of the ball 46 corresponds to the curvature of the concave bearing surfaces 56, 60. The swivel member 30 is rotatable a full 360° relative to the stationary housing and is tiltable or pivotable relative to the housing 32. The angular range of tilting movement is limited by contact between a side wall 64 of the stem 30 and an frustoconical inside surface 66 of a compression nut 68 that serves to maintain the socket 54, floating sealing member 58, and ball 46 in an assembled state. Typically, the swivel member 30 is capable of tilting through an angle of less than about 20°, although the invention is not so limited.

With reference to FIG. 2, resilient elastomer o-rings 70, 72 held within annular grooves 74, 76 inscribed about a circumferential portion of a corresponding one of the bearing surfaces 56, 60 and compressed against the convex outer surface 62 of the ball 46 provide fluid-tight dynamic fluid seals as the swivel member 30 rotates and tilts. The annular grooves 74, 76 are oriented angularly relative to the ball 46 so that each has a mouth that opens toward the convex outer surface 62 and radially relative to the center point of ball 46. The axial spacing between the socket 54 and floating sealing member 58 is such that the ball 46 has a dynamic sliding fit with o-rings 70, 72. The annular grooves 74, 76 in bearing surfaces 56, 60 and o-rings 70, 72 cooperate to provide an efficient fluid sealing action against the ball 46 without appreciably impairing relative rotation and tilting between the ball 46 and the socket assembly. An elastomer o-ring 78 received in an annular groove 80 encircling an outer surface of sealing member 58 is compressed against an inner surface 82 of the housing 32 to provide a static fluid seal.

Extending radially outward from a first portion 48a of the stem 48 of swivel member 30 is an annular flange 84 having a convex curved surface 86 facing toward an inwardly-facing concave surface 88 of the dome-shaped cap 34. A bearing component 90 inserted into the space defined between the curved surfaces 86, 88 has a curvature that conforms to the curvature of each of the curved surfaces 86, 88. The bearing component 90 may be a gasket or a coating applied to one or both of the curved surfaces 86, 88. Preferably, the bearing component 90 is a gasket that is stationary relative to the movement of the flange 84.

With continued reference to FIG. 2, bearing component 90 is formed of a material having a relatively low coefficient of friction with the material forming the annular flange 84 so that the effect of friction on movement of the flange relative to the stationary cap 34 is reduced. Specifically, the coefficient of sliding or kinetic friction of the material forming bearing component 90 against the material forming the annular flange 84 is less than, and preferably significantly less than, the coefficient of kinetic friction between the materials forming the curved surfaces 86, 88, usually a steel on steel contact. The material forming bearing component 90 should be stable at the temperature of the dispensed liquid, which transfers heat to the hydraulic fitting 10 if the liquid is heated. The material forming the bearing component may be, for example, a wear resistant polymer such as polytetrafluoroethylene (PTFE), the homopolymer of tetrafluoroethylene sold under the trademark TEFLON by DuPont (Wilmington, Del.), or Rulon®, which is a filled form of tetrafluoroethylene.

Extending axially along the length of the stem 48 is a liquid passageway 94 that communicates with a plurality of cross-drilled radial passageways 96 that transfer liquid to an annular liquid cavity 98 defined in the inwardly-facing cylindrical side wall 100 defining bore 50 in which the leading portion 48b of stem 48 is received. Opposite ends of the side wall 100 are chamfered. The radial passageways 96 communicate with the liquid cavity 98 for all possible orientations of the hydraulic fitting 28. Radial passageways 102 extending through the ball 46 transfer liquid from the liquid cavity 98 to fluid cavity 52 inside the housing 32. Extending through socket 54 are radial passageways 104 that transfer liquid from the fluid cavity 52 to a liquid passageway 106 extending axially through a neck 108 of socket 54. The liquid passageway 106 couples the hydraulic fitting 28 with the internal fluid pathway 14 of the handheld dispenser 10.

With continued reference to FIG. 2, the outer diameter of a second portion 48b of the stem 48 is smaller than the diameter of bore 50 so that stem 48 has adequate clearance to freely move within bore 50. Spaced along the axial length of the stem 48 are two inscribed circumferential grooves 110, 112 each holding one of a corresponding pair of resilient elastomer o-rings 114, 116, which are compressed against the inwardly-facing cylindrical side wall 100 surrounding bore 50. The respective mouth of each groove 110, 112 opens toward the cylindrical side wall 100 and the o-rings 114, 116 are dimensioned relative to the grooves 110, 112 so that, when uncompressed, a portion of each o-ring 114, 116 projects above the lip of the open mouth. When compressed by contact against the ball 46 in the assembled state, the o-rings 114, 116 preferably space the ball 46 from the stem 48 so that the cylindrical side wall 100 and the second portion 48b of stem 48 have a non-contacting relationship.

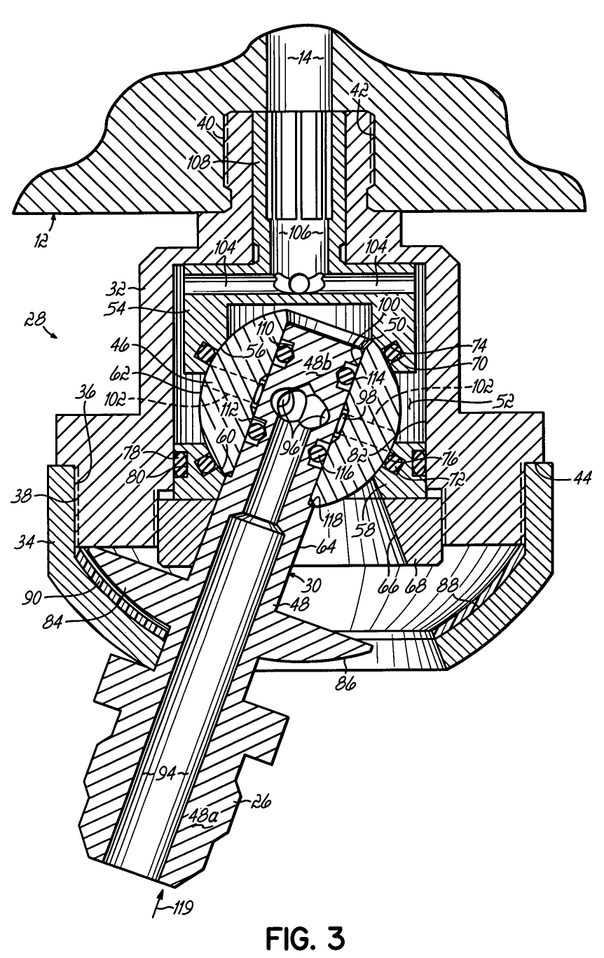

The axial travel range of the stem 48 relative to the ball 46 is limited by contact, at an inward extremum of the travel range, between a shoulder 118 defined at the junction between the portions 48a,b of stem 48 and the convex outer surface 62 of ball 46 and by contact between the curved surfaces 86, 88 at an outward extremum of the travel range. If the stem 48 is pushed inwardly relative to the ball 46 by an inwardly-directed axial force, generally indicated by reference numeral 119 on FIG. 3, applied to the supply conduit 22 (FIG. 1) and stem 48, shoulder 118 contacts the convex outer surface 62. As a result, the leading tip of the stem 48 cannot protrude beyond the convex outer surface 62 of the ball 46 and the supply passageways 96 remain in constant fluid communication with the liquid cavity 98.

If the stem 48 is pulled outwardly relative to the ball 46 by an outwardly-directed axial force, generally indicated by reference numeral 121 on FIG. 2, applied to the supply conduit 22 and stem 48 the curved surfaces 86, 88 contact and halt outward movement or withdrawal of the stem 48. As a result, the applied axial force 121 is transferred from the stem 48 to the cap 34, as diagrammatically indicated by arrow 123, and subsequently to the housing 32 and ultimately to the dispenser 12 as the dispenser 12, housing 32 and cap 34 comprise a unitary structure. Fluid communication is continuous between the supply passageways 96 and the liquid cavity 98 as the stem 48 moves inward and outward. Under normal working conditions, the stem 48 will be pulled outwardly relative to the ball 46, as the weight of the supply conduit 22 will apply an uninterrupted outward axial force to the stem 48. Additional axial forces may be applied to the stem 48 when the supply conduit 22 snags or catches against external objects in the operator's work environment.

The action of the stem 48 in response to the outward axial force 121 (FIG. 2) isolates the ball 46 so that the axial force 121 applied in an outward direction are not transferred to the ball 46. Instead, outward axial forces are transferred from the stem 48 to the cap 34 and transferred serially to the housing 32 and dispenser 12, which collectively constitute a rigid body that dampens the outward axial force applied to stem 48.

In use and with reference to FIGS. 1 and 2, liquid is directed along the length of the stem 48 through liquid passageway 94 and flows through radial passageways 96 in the stem 48, the annular liquid cavity 98, the radial passageways 102 in ball 46, the fluid cavity 52, and the radial passageways 104 in socket 54 to the liquid passageway 106 coupling the hydraulic fitting 28 with the internal fluid pathway 14 of the handheld dispenser 10. As the operator moves about carrying the handheld dispenser 10, the hydraulic fitting 28 rotates and tilts to accommodate changes in orientation while retaining an open fluid path so that liquid flow in uninterrupted to the handheld dispenser 10.

Axial forces pulling on stem 48 cause the stem 48 to move outwardly relative to the ball 46, while the o-rings 114, 116 maintain a fluid-tight seal with the sidewall 100 surrounding bore 50. The axial forces are transferred from the stem 48 to the cap 34 by contact between the curved surfaces 86, 88, as mediated by bearing member 90, and subsequently through the housing 32 to the handheld dispenser 10. More specifically, axial forces applied to the stem 48 are transferred from the flange 84 to the dome-shaped cap 34 through the threaded engagement between the threaded regions 36 and 38, through the housing 32, and through the threaded engagement between the threaded region 40 and the threaded inlet 42 to the handheld dispenser 10. As a result, such axial forces applied to the stem 48 are not transferred with a significant magnitude or at all to the ball 46, which reduces the forces applied to the o-rings 114,116 and operates to extend the longevity of the o-rings 114, 116. In particular, the operating lifetime of o-ring 116 is lengthened, as the predominately applied outward axial force would otherwise have been transferred to o-ring 116 is instead transferred by the flange 84 to the cap 34.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants' general inventive concept. The scope of the invention itself should only be defined by the appended claims, wherein we claim:

1. An apparatus for conveying a liquid, comprising:
a housing including a fluid cavity and a socket assembly positioned in said fluid cavity;
a ball member engaged for movement within said socket assembly, said ball member including a bore; and
a stem received in said bore with a liquid-tight engagement with said ball member and including a liquid passageway coupled in fluid communication with said fluid cavity, said stem being axially movable along said bore for transferring an axial force directed along said stem to said housing.

2. The apparatus of claim 1 further comprising:
at least one sealing ring compressed between said stem and said ball member to provide the liquid-tight engagement therebetween.

3. The apparatus of claim 1 wherein said stem includes a first plurality of radial passageways and said ball member includes a second plurality of radial passageways coupled for transferring the liquid from said liquid passageway in said stem to said fluid cavity.

4. The apparatus of claim 3 further comprising:
a pair of sealing rings extending around said stem and within said bore, said pair of sealing rings situated on opposite axial sides of said first plurality of radial passageways for providing the liquid-tight engagement.

5. The apparatus of claim 4 wherein said pair of sealing rings are distanced from said plurality of radial passageways such that said axial liquid passageway is coupled in fluid communication with said plurality of radial passageways as said stem moves axially along said bore.

6. The apparatus of claim 1 wherein said swivel member further includes a flange projecting radially outward from said stem.

7. The apparatus of claim 6 further comprising:
a cap attached to said housing and including an opening through which said stem projects, said flange being positioned in an open space defined between said cap and said housing, and said flange transferring the axial force from said stem to said cap.

8. The apparatus of claim 7 further comprising:
a bearing member positioned between said flange and said cap, said bearing member configured for reducing sliding friction between said flange and said cap as said ball member moves relative to said socket assembly.

9. The apparatus of claim 7 wherein said flange has a contacting relationship with said cap.

10. The apparatus of claim 1 wherein said stem includes a shoulder with a diameter larger than said bore to operate as a stop against axial movement of said stem.

11. The apparatus of claim 1 further comprising:
a dispenser having an internal fluid pathway coupled in fluid communication with said fluid cavity.

12. The apparatus of claim 11 further comprising:
a supply conduit coupled in fluid communication with said liquid passageway of said stem, said supply hose supplying the liquid to said liquid passageway.

13. A method of transferring a liquid to an internal fluid pathway of a dispenser, comprising:
mechanically coupling a housing of a hydraulic swivel fitting with the dispenser;
hydraulically coupling a liquid passageway in a stem of the swivel fitting with a supply conduit to receive a flow of the liquid;
conveying the liquid from the liquid passageway to the internal fluid pathway of the dispenser;
rotating a ball member of the swivel fitting relative to a socket assembly carried by the swivel fitting to adjust a position of the dispenser; and
transferring an axial force applied by the supply conduit to the stem of the swivel fitting from the stem to the housing and subsequently from the housing to the dispenser.

14. The method of claim 13 wherein transferring the axial force further comprises:
allowing a first portion of the stem to move axially within a bore of the ball member so that a second portion of the stem contacts the housing for transferring the axial force from the stem to the housing.

15. The method of claim 14 wherein conveying the liquid from the liquid passageway through the swivel fitting further comprises:
sealing the first portion of the stem with the bore in a fluid-tight engagement to prevent leakage therebetween as the first portion of the stem moves relative to the bore.

16. The method of claim 14 further comprising:
placing a bearing member between the second portion of the stem and the housing for reducing sliding friction between the second portion and the housing as the ball member moves relative to the socket assembly.
